(19) United States
(12) Patent Application Publication
(10) Pub. No.: US 2024/0322502 A1
(43) Pub. Date: Sep. 26, 2024

(54) Thermal Management and Cable Length Compensation System

(71) Applicant: The NOCO Company, Glenwillow, OH (US)

(72) Inventor: John Derek Williams, Anthem, AZ (US)

(21) Appl. No.: 18/603,787

(22) Filed: Mar. 13, 2024

Related U.S. Application Data
(60) Provisional application No. 63/491,779, filed on Mar. 23, 2023.

(51) Int. Cl. H01R 13/66; B60L 53/16; H02J 7/00

(52) U.S. Cl. CPC H01R 13/6683; B60L 53/16; H02J 7/0042; H02J 7/00309

(57) ABSTRACT

Systems and methods are provided for thermal management of a thermal monitoring and control plug. The plug may be used to connect an electric vehicle to an electrical energy source in order to charge the electric vehicle. To ensure real-time, accurate temperature monitoring of the thermal monitoring and control plug, a temperature detection system may be used. The temperature detection system may include a thermal truss at least partially surrounding a power conductor terminal of the thermal monitoring and control plug. A temperature sensor may be coupled to the thermal truss and configured to rapidly detect the temperature change of the power conducting terminal.

### CROSS-REFERENCE TO RELATED APPLICATIONS

This application claims priority to U.S. Provisional Application No. 63/491,779, filed Mar. 23, 2023, which is incorporated herein by reference in its entirety.

### FIELD

The present disclosure relates to thermal monitoring and control systems, and in particular to a thermal monitoring and control systems of electrical cables.

### BACKGROUND

Effective thermal management is paramount in electric vehicle (EV) charging systems, as well as other charging applications, to ensure optimal performance, safety, and longevity of the vehicle's components. As EV batteries charge, they generate heat due to internal resistance and chemical reactions. Without proper thermal management, this heat can accumulate and lead to battery degradation, reduced charging efficiency, and even safety hazards such as thermal runaway.

Moreover, thermal management extends beyond just the battery to encompass other crucial components within the charging system, such as power electronics and connectors. These components also generate heat during charging operations, and without adequate control or cooling mechanisms, they can suffer from reduced efficiency and can pose safety risks. Proper thermal management strategies help to regulate the temperature of these components, optimizing their performance and reliability. Beyond EV charging systems, other charging systems may also benefit from thermal monitoring and management of associated power electronics and connectors.

### SUMMARY

The present disclosure relates to systems and methods for thermal management of an electrical connector (e.g., a thermal monitoring and control plug for charging an electric vehicle) that may utilize a thermal truss when measuring the temperature of at least one electrical transfer component (e.g., a power conductor terminal). The thermal truss may function to rapidly transfer thermal energy produced by the electrical transfer component to a temperature sensor, such that the temperature sensor may measure changes in temperature of the electrical connector sooner than a connector that has no thermal truss. In some implementations, the thermal truss may take a specific form that permits this rapid thermal conduction, such as by partially surrounding one or more of the electrical transfer components. Among other advantages, the rapid temperature reading may permit faster and more accurate predictions of when the electrical connection plug may exceed a critical temperature. This information can then be used to take corrective action, such as reducing or turning off the electrical energy being transferred through the electrical connector.

In one aspect, the present disclosure provides a thermal monitoring and control plug. The plug may include a power conductor terminal configured to electrically couple to a vehicle charging port and transfer electrical energy to the vehicle charging port. The plug may also include a temperature detection system that includes a thermal truss at least partially surrounding the power conductor terminal and a temperature sensor coupled to the thermal truss and configured to detect the temperature change of the power conducting terminal.

In another aspect, the present disclosure provides an electrical connection unit. The electrical connection unit may include a first power conductor terminal configured to transfer electrical energy to a device and a second power conductor terminal configured to transfer electrical energy to the device. The electrical connection unit may also include a temperature detection system having a thermal truss at least partially surrounding the first power conductor terminal and the second power conductor terminal and a temperature sensor coupled to the thermal truss and configured to detect the temperature change of a singular power conducting terminal.

In yet another aspect, the present disclosure provides a method of thermal management of an electrical connection plug. The method may include measuring temperature data of a power conductor terminal using a temperature sensor coupled to the thermal truss that at least partially surrounding the power conductor terminal. The power conductor terminal may be configured to electrically couple to a vehicle charging port and transfer electrical energy thereto. The method may also include determining if the electrical connection plug will exceed a critical temperature of the thermal monitoring and control plug based on the measured temperature data.

### BRIEF DESCRIPTION OF DRAWINGS

FIG. 1A is a diagram illustrating a thermal management and cable length compensation system having been connected to an electric vehicle.

FIG. 1B is a diagram illustrating a front, perspective view of a thermal monitoring and control plug, which forms a part of the thermal management and cable length compensation system shown in FIG. 1A.

FIG. 2A is a diagram illustrating an angular, rear view of the thermal monitoring and control plug.

FIG. 2B is a diagram illustrating a rear view of the thermal monitoring and control plug shown in FIG. 2A.

FIG. 3A is a diagram illustrating an angular, front view of the thermal truss embedded in the thermal monitoring and control plug.

FIG. 3B is a diagram illustrating an angular, rear view of the thermal truss embedded in the thermal monitoring and control plug shown in FIG. 3A.

FIG. 4 is a diagram illustrating a quarter cross-sectional view of the thermal monitoring and control plug.

FIG. 5 is a diagram illustrating a thermal truss of the thermal monitoring and control plug.

FIG. 6 is a diagram illustrating an alternative embodiment of a thermal truss for use in the thermal monitoring and control plug.

FIG. 7A is a diagram illustrating a heat map of an angled, rear view of the thermal monitoring and control plug.

FIG. 7B is a diagram illustrating a heat map of an angled, partially-exploded, rear view of the thermal monitoring and control plug.

FIG. 8A is a chart illustrating a finite elements transient analysis of an thermal monitoring and control plug with a thermal truss.

FIG. 8B is a chart illustrating a finite elements transient analysis of an thermal monitoring and control plug without a thermal truss.

FIG. 9 is a chart illustrating a finite elements transient analysis of a thermal monitoring and control plug with a thermal truss and of a thermal monitoring and control plug without a thermal truss.

FIG. 10 is a diagram illustrating a temperature detection control system.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer-readable medium and executed by a computer or processor, whether such computer or processor is explicitly shown. While each of the figures illustrates a particular embodiment for purposes of illustrating a clear example, other embodiments may omit, add to, reorder, and/or modify any of the elements shown in the figures.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

It is to be understood that the phraseology and terminology employed herein are for the purpose of description and should not be regarded as limiting. For example, the use of a singular term, such as, “a” is not intended as limiting of the number of items. Also the use of relational terms, such as but not limited to, “top,” “bottom,” “left,” “right,” “upper,” “lower,” “down,” “up,” “side,” are used in the description for clarity and are not intended to limit the scope of the invention or the appended claims. Further, it should be understood that any one of the features can be used separately or in combination with other features. Other systems, methods, features, and advantages of the invention will be or become apparent to one with skill in the art upon examination of the detailed description. It is intended that all such additional systems, methods, features, and advantages be included within this description, be within the scope of the present invention, and be protected by the accompanying claims.

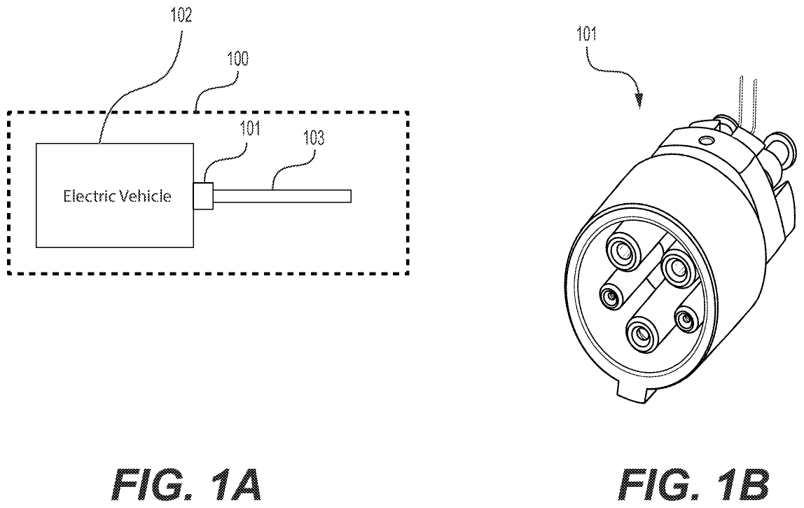

FIG. 1A depicts a thermal management and cable length compensation system 100, in accordance with some embodiments. In the example embodiment depicted in FIG. 1A, the thermal management and cable length compensation system 100 includes an electric vehicle 102. The thermal management and cable length compensation system 100 may further comprise a thermal monitoring and control plug 101 and an electric cable 103. The thermal monitoring and control plug 101 may be used to attach and detach the electric cable 103 to and from the electric vehicle 102. The electric cable 103 may distribute charge to the electric vehicle 102 when the electric cable 103 is attached to the electric vehicle 102 via the thermal monitoring and control plug 101. In this manner, the thermal monitoring and control plug 101 may function as a connector between an electrical energy source and a device to be charged, such as the depicted electric vehicle 102.

FIG. 1B depicts a thermal monitoring and control plug 101, in accordance with some embodiments. In the example embodiment depicted in FIG. 1B, the thermal monitoring and control plug 101 is implemented in an SAE J1772 Electric Vehicle (EV) plug standard. The SAE J1772 EV is an open standard and may be relied upon by various electric vehicle chargers (e.g., NOCO EVX Series Level 2 EV Chargers), especially those produced in or for North America. The systems and methods disclosed herein may be expanded to other standards and interfaces (e.g., European IEC Standard interfaces) relating to electric vehicles. Furthermore, the systems and methods disclosed herein may be expanded to areas other than electric vehicles, including battery pack and power conversation systems.

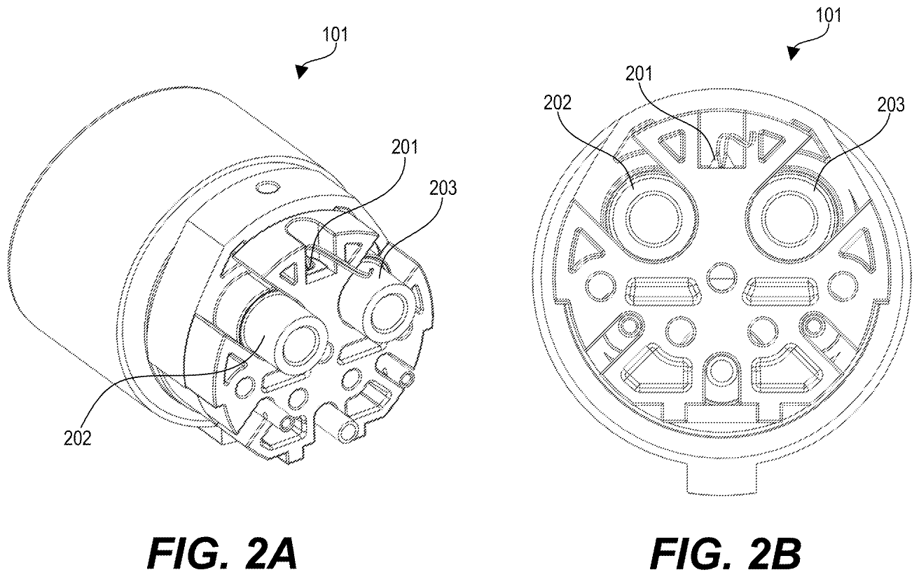

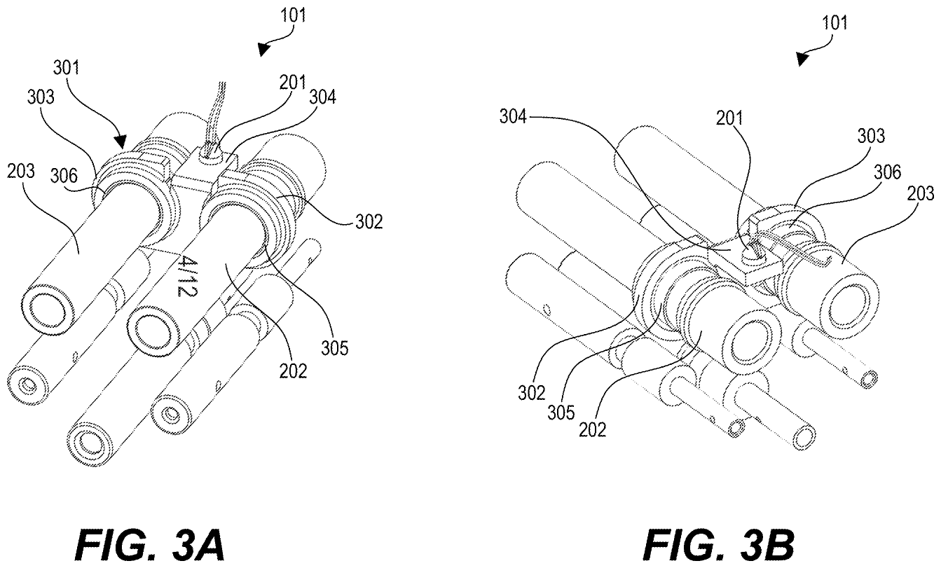

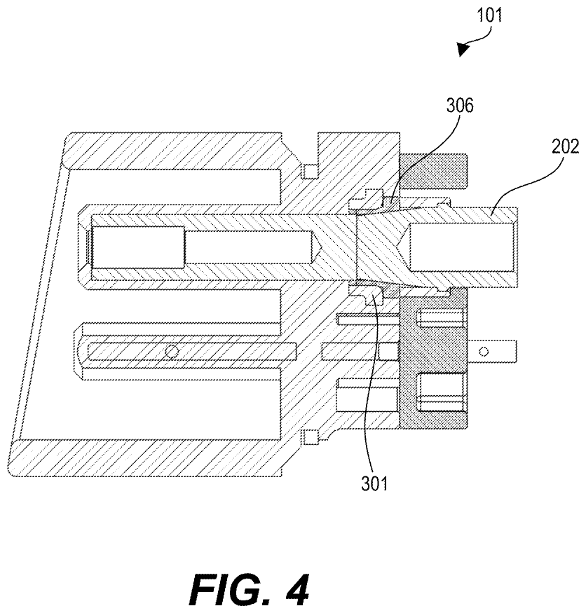

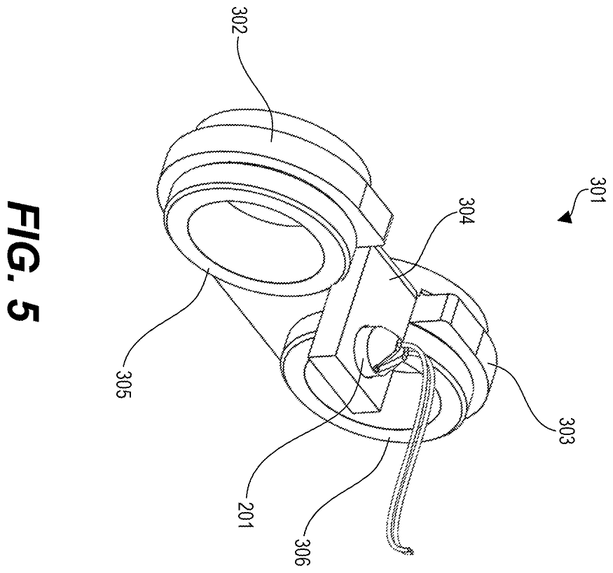

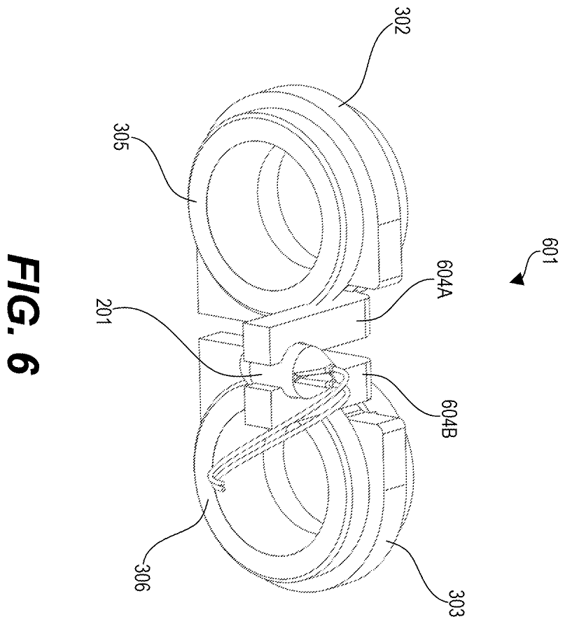

FIG. 2A depicts an angular view of a rear side of the thermal monitoring and control plug 101, in accordance with some embodiments. FIG. 2B depicts a direct view of a rear side of the thermal monitoring and control plug 101, in accordance with some embodiments. The thermal monitoring and control plug 101 may comprise a temperature detection system that includes a thermal truss (not visible). The thermal truss is depicted in FIGS. 5-6 below, and is included in the thermal monitoring and control plug assemblies depicted in FIGS. 3A-4. The thermal truss may be positioned in close proximity to a first power conductor 202 and a second power conductor 203 of the thermal monitoring and control plug 101.

The temperature sensor 201 and thermal truss may be configured to detect either the aggregate temperature change of multiple power contacting terminals, a singular power conducting terminal, or any arrangement of power conducting terminals dependent on the selected configuration of the thermal monitoring and control plug 101. This feature may be advantageous, because various electric vehicle charging modes may permit various line connections to the power grid (e.g., 110V, 220V).

FIGS. 3A-3B depict views of a thermal truss 301 embedded in the thermal monitoring and control plug 101, in accordance with some embodiments. The thermal truss 301 may be constructed out of one or more conductive materials (e.g., copper) depending on the specific calibration requirements of a given system. The thermal truss 301 may thermally unite the first and second power conductors 202, 203 of the thermal monitoring and control plug 101, such that a single temperature sensor (e.g., thermistor, thermocouple, etc.) 201 may be used to detect the temperature changes of the first and second power conductors 202, 203 of the thermal monitoring and control plug 101. In the example embodiment depicted in FIG. 3A, the thermal truss 301 may surround (e.g., girdle) terminals of the first and second power conductors 202, 203 and may be in close proximity to wire-crimped ends of the power conductor terminals. The thermal truss 301 may partially or wholly surround the first and second power conductors 202, 203. As will be further described, the thermal truss 301 may be sufficiently isolated from the power conductor terminals, such as by using one or more electrical isolators, so that the voltage creepage and clearance complies with the applicable legal and regulatory requirements.

The thermal truss 301 may include a first surrounding element 302 and a second surrounding element 303. The first surrounding element 302 may surround the first power conductive terminal 202 and the second surrounding element 303 may surround the second power conductive terminal 203. The first and second surrounding elements (302, 303) may be coupled to an integral platform 304 positioned between the first surrounding element 302 and the second surrounding element 303. The temperature sensor 201 may be mounted on the integral platform 304. By employing proper calibration techniques and active current detection, which conductor or conductors are active during a given charging event may be determined.

The thermal monitoring and control plug 101 may also include electrical isolators 305, 306 (also referred to herein as a “voltage isolator”). The electrical isolators 305, 306 may function to prevent unwanted electrical transfer between the thermal truss 301 and the first and second power conductors 202, 203, and thereby prevent an undesirable electrical short. In order to achieve this functionality, the electrical isolators 305, 306 may be formed of a material with a low electrical conductivity, such as a polymeric material. The electrical isolators 305, 306 may specifically be formed with a low electrical conductivity, but a high thermal conductivity to promote thermal transfer between the thermal truss 301 and the power conductors 202, 203. In particular, and as shown, a first electrical isolator 305 may be interposed between the thermal truss 301 and the first power conductive terminal 202, while a second electrical isolator 306 may be interposed between the thermal truss 301 and the second power conductive terminal 203.

FIG. 4 depicts a quarter cross-section of a thermal monitoring and control plug 101, in accordance with some embodiments. In the example embodiment depicted in FIG. 4, the thermal truss 301 is fully embedded in the body of the thermal monitoring and control plug 101. For example, the thermal truss 301 may be insert molded into the plug body housing such that there is a solid thermal stack to the temperature sensor 201. The solid thermal stack may be advantageous, because the thermal monitoring and control plug 101 may operate as a transient thermal detection device, measuring the change in temperature with respect to the change in time over which that temperature change occurred (e.g., degrees Celsius/see). Various features of the thermal monitoring and control plug 101 (e.g., the close proximity of the thermal truss to the first and second power conductors) may enable the temperature sensor 201 to quickly detect changes in temperature over short time intervals. These features may allow software within the thermal management and cable length compensation system 100 to respond more quickly than a device that does not incorporate a thermal truss. As depicted, the associated second electrical isolator 306 is positioned between the second power conductive terminal 202 and the thermal truss 301.

FIG. 5 depicts a thermal truss 301. As depicted, the first surrounding element 302 may be configured to completely surround a first power conductor terminal, while a second surrounding element 303 may be configured to completely surround a second power conductor terminal, such as by having each surrounding element formed of a ring or similar shape. Electrical isolators 305, 306 may be positioned along the inner edge of the surrounding elements 302, 303, such that any object enclosed by the surrounding elements 302, 303 may be electrically isolated from them. The integral platform 304 may be positioned between the first surrounding element 302 and the second surrounding element 303, such that the integral platform 304 may directly conduct heat flux via direct conductivity to the temperature sensor 201. The temperature sensor 201 may be positioned such that it solely contacts the thermal truss 301. In this manner, the temperature sensor 201 may be thermally isolated, such that surrounding components of the thermal monitoring and control plug 101 do not contact and thermally spread heat flux away from the temperature sensor 201.

FIG. 6 depicts an alternative embodiment of a thermal truss 601 for use in the thermal monitoring and control plugs described herein. As shown, a thermal interface, depicted as a slot within the integral platform may be utilized, thereby splitting the integral platform into a first portion 604A and a second portion 604B. With the inclusion of this thermal interface, the thermal conductivity pathway may be preferentially biased towards the temperature sensor 201. In other words, since the first surrounding element 302 is thermally coupled to the second surrounding element 303 through only the temperature sensor 201, heat flux may be more-directly channeled to the temperature sensor 201. Beyond the use of a slot or gap for the thermal interface, other implementations may be utilized to control the thermal conductivity, including, for example, the incorporation of thermally isolating materials in place of a slot or gap.

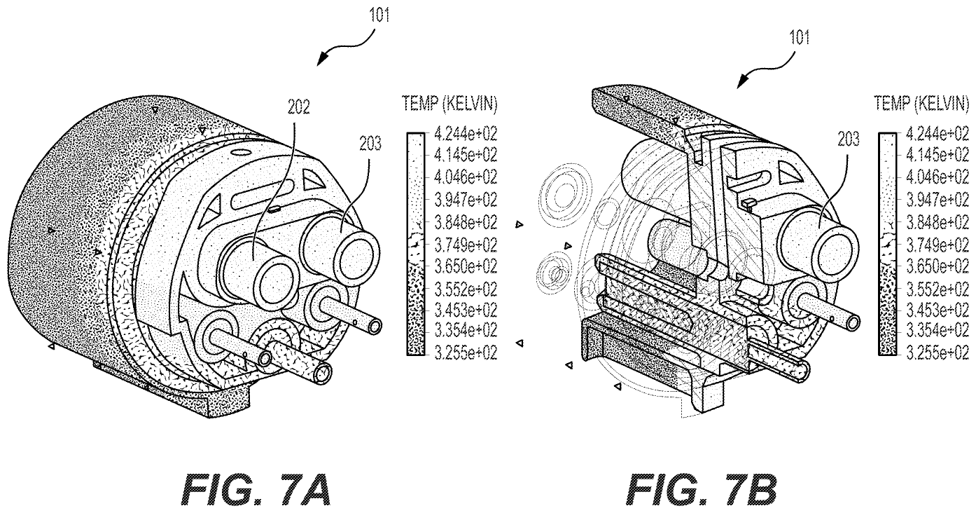

FIG. 7A depicts a heat map of a thermal monitoring and control plug, in accordance with some embodiments. As shown in FIG. 7A, the area surrounding the first and second power conductors (202, 203) generates a relatively high amount of heat, while other areas of the thermal monitoring and control plug 101 generate a relatively low amount of heat. This may occur, for example, due to electrical current flowing through the first and second power conductors (202, 203) during a charging operation of the thermal monitoring and control plug 101.

FIG. 7B depicts a heat map of a cut-away view of a thermal monitoring and control plug, in accordance with some embodiments. As depicted in the cut-away view of the thermal monitoring and control plug 101, the relatively high temperature of the first and second power conductors (202, 203) can extend along the length of the first and second power conductors (202, 203).

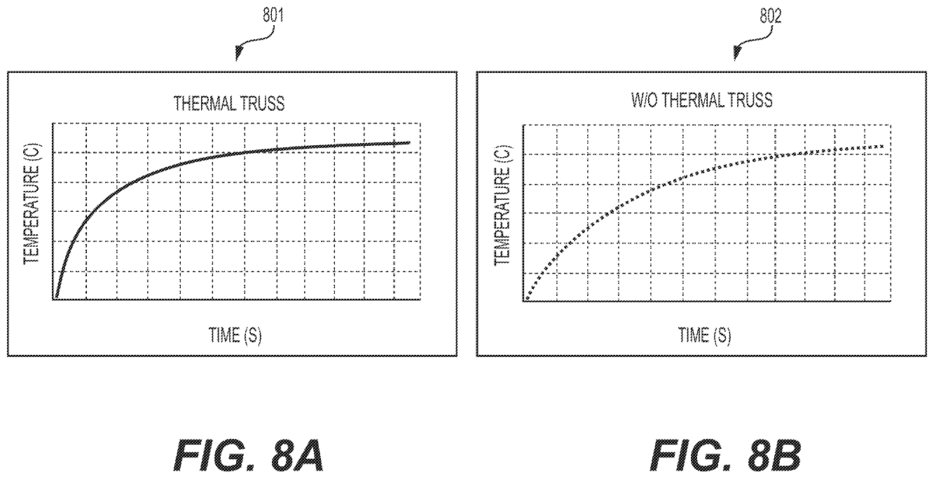

FIG. 8A depicts a finite elements transient analysis of an thermal monitoring and control plug with a thermal truss, in accordance with some embodiments. The temperature curve 801 represented by FIG. 8A may be measured, for example, by the temperature sensor 201. In the example embodiment depicted in FIG. 8A, the temperature sensor 201 detects a relatively quick change in temperature, as illustrated by the steep curve at initial (e.g., early) time values.

FIG. 8B depicts a finite elements transient analysis of a thermal monitoring and control plug without a thermal truss, in accordance with some embodiments. In the example embodiment depicted in FIG. 8B, there is a relatively slow change in temperature, as illustrated by the relatively gradual (e.g., mild) slope at initial time values.

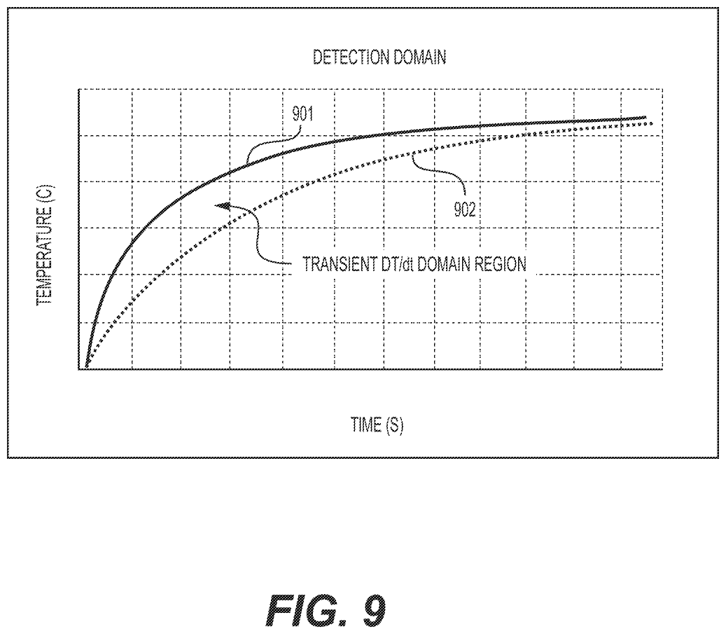

FIG. 9 depicts a finite elements transient analysis of a thermal monitoring and control plug with a thermal truss 901 and of a thermal monitoring and control plug without a thermal truss 902, in accordance with some embodiments. As illustrated in FIG. 9, a system that incorporates a thermal truss may detect temperature changes more quickly than a system not incorporating a thermal truss. This faster (e.g., earlier) rate of temperature detection may be used to directly detect potential thermal overshoot of a critical temperature of the thermal monitoring and control plug 101. This critical temperature may be, for example, an upper limit of an operating temperature of the thermal monitoring and control plug 101. Furthermore, this faster rate of temperature detection through the use of the thermal truss 301 may be used to determine a length of the cable 103 coupled to the thermal monitoring and control plug 101. This determination may be made, for example, because voltage drops associated with longer cable lengths may result in a faster temperature rise of the thermal monitoring and control plug 101. This determination can be used to compensate (e.g., control) current roll-off and avoid thermal overshoot, as described further below.

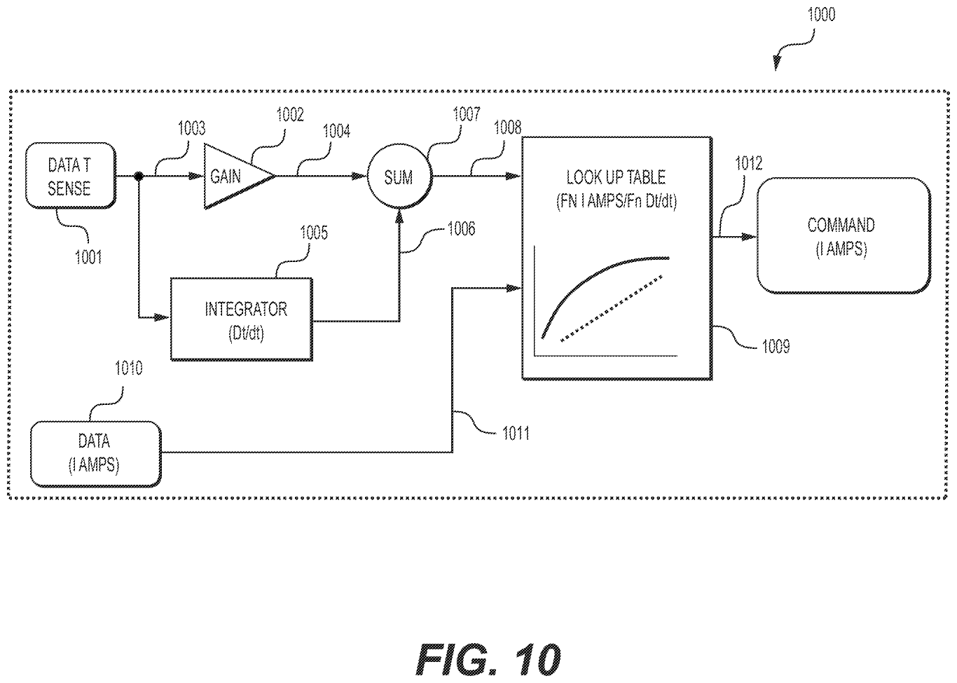

FIG. 10 depicts a block diagram of a temperature detection control system, in accordance with some embodiments. In the example embodiment depicted in FIG. 10, the temperature detection control system 1000 includes a temperature block 1001. The temperature block 1001 may represent, for example, the temperature detected by the temperature sensor 201. The temperature detection control system 1000 may further comprise an amplifier 1002 coupled to the temperature block 1001. The amplifier 1002 may apply a predetermined or adjustable gain to an output 1003 of the temperature block 1001. The amplifier 1002 may generate an amplified temperature signal 1004 based on the output 1003 of the temperature block 1001. The output 1003 of the temperature block 1001 may also be received at an integrator 1005. The integrator 1005 may determine the temperature change (e.g., of the thermal truss 301) with respect to the corresponding time interval over which the temperature has changed. The integrator 1005 may generate an integration signal 1006.

The integration signal 1006 and the amplified temperature signal 1004 may be received at an adder 1007. The adder 1007 may add the integration signal 1006 and the amplified temperature signal 1004 and may generate a temperature change signal 1008 based on the amplified temperature signal 1004 and the integration signal 1006. The temperature change signal 1008 may be received at a look-up table 1009. Furthermore, a current signal 1011 may be received from a current block 1010 at a the look-up table 1009. The current signal 1011 may represent the present amount of current flowing through the first and second power conductors (202, 203). The look-up table 1009 may compare the temperature change signal 1008 at the corresponding current signal 1011 to a permissible (e.g., acceptable) temperature change signal at the specific amount of current represented by the current signal 1011. The look-up table 1009 or a separate component of the temperature detection control system 1000 may also compare the temperature of the temperature sensor 201 to a temperature threshold value.

Based on the relationship of the temperature change signal 1008 at the corresponding current signal 1011 to the permissible temperature change signal at the specific amount of current represented by the current signal 1011, the look-up table 1009 may generate a command signal 1012. The command signal 1012 may also or alternatively be based on the comparison of the temperature sensor temperature to the temperature threshold value. The command signal 1012 may represent, for example, a command to increase or decrease the charging current flowing through the electric cable 103. Based on the command signal 1012, the temperature detection control system 1000 may adjust the current flowing through the first and second power conductors (202, 203). Thus, the temperature detection control system 1000 may rapidly detect and intervene to prevent thermal over-run.

Furthermore, the temperature detection control system 1000 may measure the difference in a base current of a power source (e.g., a power source supplying power to the electrical cable 103) to the actual current measured at or near the first and second power conductors (202, 203). This difference may be compared to a voltage drop across the electrical cable 103. The comparison may be used to determine the size of the electrical cable 103. Based on the size of the electrical cable 103, the temperature detection control system may calibrate (e.g., adjust) the current roll-off to maintain an acceptable temperature of the first and second power conductors (202, 203) (e.g., a temperature below the temperature threshold value).

It will be appreciated by those skilled in the art that changes could be made to the embodiments described above without departing from the broad inventive concept thereof. It is understood, therefore, that the invention disclosed herein is not limited to the particular embodiments disclosed, and is intended to cover modifications within the spirit and scope of the present invention.

What is claimed is:

1. A thermal monitoring and control plug, the plug comprising:
a power conductor terminal configured to:
electrically couple to a vehicle charging port; and
transfer electrical energy to the vehicle charging port;
a temperature detection system that includes:
a thermal truss at least partially surrounding the power conductor terminal; and
a temperature sensor coupled to the thermal truss and configured to detect a temperature change of the power conducting terminal.

2. The charging system plug of claim 1, wherein the thermal truss completely surrounds the power conductor terminal.

3. The charging system plug of claim 2, further comprising:
an electrical isolator interposed between the thermal truss and the power conductor terminal.

4. The charging system plug of claim 2, further comprising:
a second power conductor terminal configured to transfer electrical energy to the vehicle charging port, wherein the thermal truss at least partially surrounds the second power conductor terminal.

5. The charging system plug of claim 4, wherein the thermal truss wholly surrounds the second power conductor terminal.

6. The charging system plug of claim 4, further comprising:
a second electrical isolator interposed between the thermal truss and the second power conductor terminal.

7. The charging system plug of claim 1, further comprising:
a plug housing surrounding at least a portion of the power conductor terminal, wherein the plug housing completely encloses the thermal truss.

8. The charging system plug of claim 1, wherein the thermal truss is formed of two pieces separated by a gap, with the temperature sensor coupled to both pieces of the thermal truss.

9. The charging system plug of claim 1, wherein the thermal truss is formed of a conductive metal.

10. The charging system plug of claim 9, wherein the thermal truss is formed of copper.

11. The charging system plug of claim 1, wherein the power conductor terminal is configured to transfer electrical energy at multiple voltages.

12. An electric connection unit comprising:
a first power conductor terminal configured to transfer electrical energy to a device;
a second power conductor terminal configured to transfer electrical energy to the device;
a temperature detection system that includes:
a thermal truss at least partially surrounding the first power conductor terminal and the second power conductor terminal; and
a temperature sensor coupled to the thermal truss and configured to detect a temperature change of a singular power conducting terminal.

13. The connection unit of claim 12, wherein the thermal truss includes:
a first surrounding element completely surrounding the first power conductor terminal;
a second surrounding element completely surrounding the second power conductor terminal; and
an integral platform positioned between the first surrounding element and the second surrounding element.

14. The connection unit of claim 13, wherein the temperature sensor contacts the integral platform.

15. The connection unit of claim 13, wherein thermal truss further includes:
a first electrical isolator interposed between the first surrounding element and the first power conductor terminal; and
a second electrical isolator interposed between the first surrounding element and the first power conductor terminal.

16. The connection unit of claim 13, wherein the first surrounding element is thermally coupled to the second surrounding element through only the temperature sensor.

17. The connection unit of claim 12, wherein the thermal truss is formed of a conductive metal.

18. The connection unit of claim 12, wherein the thermal truss is formed of copper.

19. A method of thermal management of an electrical connection plug, the method comprising:
measuring temperature data of a power conductor terminal using a temperature sensor coupled to a thermal truss that at least partially surrounding the power conductor terminal, wherein the power conductor terminal is configured to electrically couple to a vehicle charging port and transfer electrical energy thereto; and
determining if the electrical connection plug will exceed a critical temperature of the thermal monitoring and control plug based on the measured temperature data.

20. The method of claim 19, further comprising:
determining a length of the cable coupled to the thermal monitoring and control plug based on the measured temperature data.
